(19) United States
(12) Patent Application Publication
(10) Pub. No.: US 2011/0231303 A1
(43) Pub. Date: Sep. 22, 2011

(54) TERMINAL DEVICE AND DIGITAL CONTENT MANAGING APPARATUS

(75) Inventors: HO-LEUNG CHEUNG, Shenzhen City (CN); KUAN-HONG HSIEH, Tu-Cheng (TW); CHENG-HAO CHOU, Tu-Cheng (TW)

(73) Assignee: HON HAI PRECISION INDUSTRY CO., LTD., Tu-Cheng (TW)

(21) Appl. No.: 12/853,231

(22) Filed: Aug. 9, 2010

(30) Foreign Application Priority Data
Mar. 18, 2010 (CN) 201010126810.3

(51) Int. Cl. H04L 9/32; G06Q 30/00; G06Q 40/00

(52) U.S. Cl. 705/39; 713/155

(57) ABSTRACT

A terminal device for receiving encrypted digital content provided by a digital content managing apparatus through a digital transmission system is provided. The terminal device comprise a processor which includes an ID obtaining module configured for obtaining an identification (ID) of the terminal device; and a decryption module configured for generating the password according to the ID and decrypting the encrypted digital content received by the receiving unit. The ID is provided to the digital content apparatus to generate a password to encrypt digital content subscribed by the terminal device. A digital content managing apparatus accessible for the terminal device is also provided.

### BACKGROUND

1. Technical Field

The present disclosure generally relates to terminal devices and, particularly, to a terminal device and a digital content managing apparatus accessible to the terminal device.

2. Description of the Related Art

Nowadays, most paid digital content is encrypted by providers and then sent to authorized clients, who have paid for the digital content, allowing them to access the content with a password. However, sometimes a password is hacked by non-authorized users and the encrypted digital content accessed.

Therefore, what is needed is a digital content distribution system to overcome the above-mentioned shortcomings.

### BRIEF DESCRIPTION OF THE DRAWINGS

The components in the drawings are not necessarily drawn to scale, the emphasis instead being placed upon clearly illustrating the principles of a terminal device and a digital content managing apparatus accessible to the terminal device. Moreover, in the drawings, like reference numerals designate corresponding parts throughout the several views.

FIG. 1 is a block diagram of a digital content distribution system including a terminal device and a digital content managing apparatus that can be accessed by the terminal device in accordance with an exemplary embodiment.

FIG. 2 is a block diagram of the terminal device of the digital content distribution system of FIG. 1.

FIG. 3 is a block diagram of the digital content managing apparatus of the digital content distribution system of FIG. 1.

### DETAILED DESCRIPTION

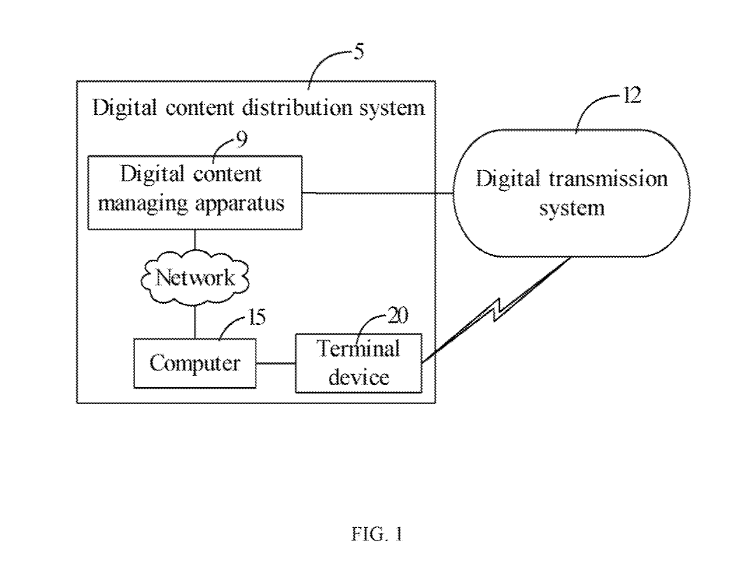

Referring to FIG. 1, a digital content distribution system 5 includes a digital content managing apparatus 9, a computer 15, and at least one terminal device 20. The digital content managing apparatus 9 stores various digital content, which can be transmitted to at least one terminal device 20 through a digital transmission system 12. The computer 15 can communicate with the digital content managing apparatus 9 to subscribe to the digital content through networks, such as the Internet. In the embodiment, there is one terminal device 20. The terminal device 20 can be a mobile phone, an e-reader, a personal data assistant (PDA), or similar device. The digital content managing apparatus 9 may be a network server.

In the embodiment, an identification (ID) of the terminal device 20 is assigned to and pre-stored in the terminal device 20 during production. The computer 15 receives the ID of the terminal device 20 after the terminal device 20 is connected to the computer 15. The computer 15 accesses the digital content managing apparatus 9 through the network and transmits the ID of the terminal device 20 to the digital content management apparatus 9. The digital content managing apparatus 9 displays options menus, which list options such as titles of various digital content on the computer 15 and records selected subscription options of the terminal device 20. The digital content managing apparatus 9 generates a password based on the ID and encrypts the digital content associated with the subscription options using the password, and then transmits the encrypted digital content to the terminal device 20 through the digital transmission system 12. The terminal device 20 is also capable of generating the password based on the ID of the terminal device in a way similar to the generating of the password in the digital content managing apparatus 9 and decrypting the encrypted digital content using the password. By doing so, the encrypted digital content can only be decrypted by the terminal device 20 with the specific ID rather than other terminal devices, thus the encrypted digital content cannot be copied, displayed or accessed by other electronic devices.

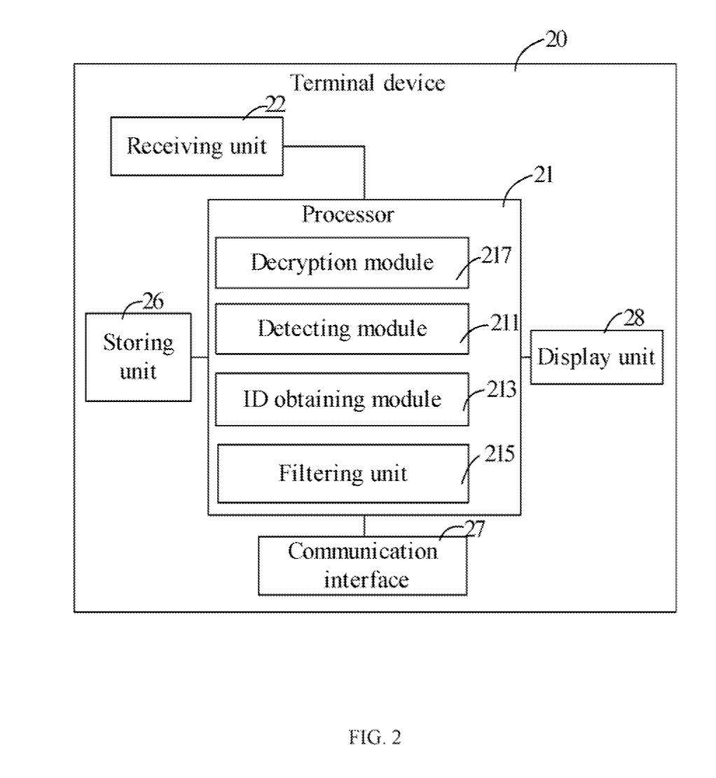

Referring also to FIG. 2, the terminal device 20 includes a receiving unit 21, a processor 22, a storing unit 26, a communication interface 27, and a display unit 28. The storing unit 26 is configured to store the ID of the terminal device 20. The terminal device 20 can be connected to the computer 15 through the communication interface 27. The communication interface 27 can be a universal serial bus (USB) interface, a BLUETOOTH interface, an infrared interface, a WIFI interface, or similar connection.

The receiving unit 21 is configured to receive the encrypted digital content from the digital transmission system 12.

The processor 22 includes a detecting module 211, an ID obtaining module 213, a filtering unit 215, and a decryption module 217.

The detecting module 211 is configured to detect whether the terminal device 20 is connected to the computer 15 through the communication interface 27.

The ID obtaining module 213 is configured to obtain the ID from the storing unit 26 when the terminal device 20 is connected to the computer 15. The ID is provided to the digital content apparatus 9 through the computer 15, so that the digital content managing apparatus 9 generates a password to encrypt digital content subscribed to by the terminal device 20. In an alternative embodiment where the terminal device 20 accesses the digital content managing apparatus 9 directly without the participation of the computer 15, the ID is provided to the digital content apparatus 9 directly without being transferred by the computer 15.

The decryption module 217 is configured to generate the password according to the ID and decrypts the encrypted digital content after the user has entered the correct password. The display unit 28 displays the decrypted digital content.

The filtering unit 215 is configured to filter unwanted content, for example advertisements, from the decrypted digital content.

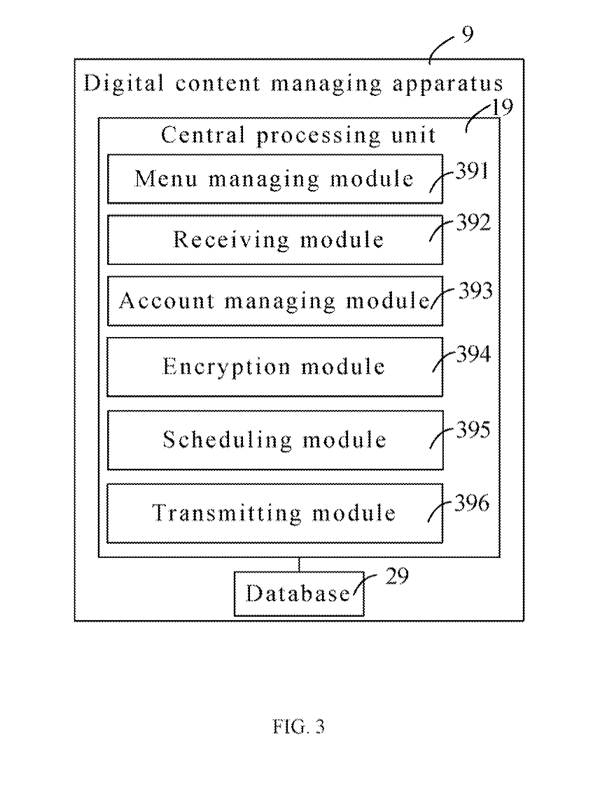

Referring also to FIG. 3, the digital content managing apparatus 9 includes a central processing unit 19. The central processing unit 19 is capable of accessing a database 29 which stores various digital content and a plurality of menus each listing options of the various digital content. In an embodiment, the database 29 is integrated into the digital content managing apparatus 9. In an alternative embodiment, the database 29 is stored in a device external to the digital content managing apparatus 9.

The central process unit 19 includes a menu managing module 391, a receiving module 392, an account managing module 393, an encryption module 394, a scheduling module 395, and a transmitting module 396.

The menu managing module 391 is configured to display the menus listing options of the various digital content stored in the database 29 to the terminal device 20, which accesses the digital content managing apparatus 9 through the computer 15. In the embodiment, the options menus are displayed on the computer 15 through the network and subscribed options of the menus in response to user inputs. In an alternative embodiment where the terminal device 20 accesses the digital content managing apparatus 9 directly without the participation of the computer 15, the menus listing options of various digital content are displayed on the display unit 28 of the terminal device 20.

The receiving module 392 is configured to receive the ID of the terminal device 20 and subscribed options of the menus from the terminal device 20. In the embodiment, the receiving module 392 receives the ID of the terminal device 20 and subscribed options of the menus through a transceiver of the digital content managing apparatus 9.

The account managing module 393 is configured to determine which subscribed option needs to be paid and takes out the fee from a provided bank account.

The encryption module 394 is configured to generate the password based on the ID of the terminal device 20 after the account managing module 392 takes out the fee from the provided account, and encrypts digital content subscribed to.

The scheduling module 395 is configured to schedule the transmission time of the encrypted digital content.

The transmitting module 396 is configured to transmit the encrypted digital content with scheduled transmission time to the digital transmission system 12. The digital transmission system 12 transmits the digital content in the scheduled time to the terminal device 20. In the embodiment, the receiving module transmits the encrypted digital content with scheduled transmission time to the digital transmission system 12 through the transceiver.

It is understood that the disclosure may be embodied in other options without departing from the spirit thereof. Thus, the present examples and embodiments are to be considered in all respects as illustrative and not restrictive, and the disclosure is not to be limited to the details given herein.

What is claimed is:

1. A terminal device comprising:
a receiving unit configured for receiving encrypted digital content provided by a digital content managing apparatus through a digital transmission system; and
a processor comprising:
an ID obtaining module configured for obtaining an identification (ID) of the terminal device, and providing the ID to the digital content managing apparatus to generate a password to encrypt digital content subscribed by the terminal device; and
a decryption module configured for generating the password according to the ID and decrypting the encrypted digital content received by the receiving unit.

2. The terminal device as claimed in claim 1, further comprising a communication interface configured for connecting the terminal device to a computer.

3. The terminal device as claimed in claim 2, further comprising a detecting module configured for detecting whether the terminal device is connected to the computer via the communication interface.

4. The terminal device as claimed in claim 2, wherein the ID obtaining module obtains the ID when the established connection between the terminal device and the computer via the communication is detected by the detecting module, and the ID obtaining module is configured to send the ID to the digital content apparatus via the computer.

5. The terminal device as claimed in claim 1, further comprising a storing unit configured for storing the ID of the terminal device.

6. The terminal device as claimed in claim 1, further comprising a display unit configured for displaying the decrypted digital content.

7. The terminal device as claimed in claim 3, wherein the communication interface is selected from the group consisting of a universal serial bus (USB) interface, a BLUETOOTH interface, an infrared interface, and a WIFI interface.

8. The terminal device as claimed in claim 1, wherein the terminal device is selected from the group consisting of a mobile phone, an e-reader, and a PDA.

9. The terminal device as claimed in claim 1, wherein the processor further comprises a filtering unit configured for filtering unwanted information from the decrypted digital content.

10. The terminal device as claimed in claim 1, further comprising a display unit for displaying the encrypted digital content.

11. A digital content managing apparatus accessible to terminal devices, comprising:
a central processing unit comprising:
a menu managing module configured for displaying menus listing options of various digital content stored in a database to a terminal device which accesses the digital content managing apparatus;
a receiving module configured for receiving an ID of the terminal device and subscribed options of the menus from the terminal device;
an encryption module configured for generating a password according to the ID of the terminal device and encrypting the digital content associated with the subscribed options using the password; and
a transmitting module configured for transmitting the encrypted digital content to the terminal device via a digital transmission system, the encrypted digital content is decryptable using the password generated by the terminal device according to the ID of the terminal device.

12. The digital content managing apparatus as claimed in claim 11, further comprising a scheduling module configured for scheduling the transmission time of the encrypted digital content, wherein the transmitting module is further configured to transmit the scheduled transmission time accompanying the encrypted digital content to the digital transmission system, thereby the digital transmission system transmissions the encrypted digital content to the terminal device in the scheduled transmission time.

13. The digital content managing apparatus as claimed in claim 11, further comprising an account managing module configured for determining one or more charge options from the subscribed options and charging the fee for the one or more charge options against a pre-authorized bank account.

14. The digital content managing apparatus as claimed in claim 13, wherein the encryption module is configured for encrypting the digital content associated with the subscribed options after the fee is charged.

15. The digital content managing apparatus as claimed in claim 11, further comprising the database.

16. The digital content managing apparatus as claimed in claim 15, wherein the database is stored in a device external to the central processing unit.
